(19) United States
(12) Patent Application Publication
(10) Pub. No.: US 2009/0057932 A1
(43) Pub. Date: Mar. 5, 2009

(54) MANUFACTURING METHOD OF KEYPAD PANEL

(76) Inventor: Yu-Chih CHANG, Gueishan (TW)

Correspondence Address: HDLS Patent & Trademark Services, P.O. BOX 220746, CHANTILLY, VA, 20153-0746, US

(21) Appl. No.: 11/876,012

(22) Filed: Oct. 22, 2007

(30) Foreign Application Priority Data
Aug. 28, 2007 (TW) 096131785

(51) Int. Cl. B29D 11/00

(52) U.S. Cl. 264/1.38

(57) ABSTRACT

A manufacturing method of keypad panel includes the steps of preparing a mold formed by assembling a mold base, a transparent mold cavity and a fixed board; coating an ultraviolet curing resin on surfaces of the mold base and the transparent mold cavity of the mold; attaching a transparent or non-transparent plastic thin film onto the ultraviolet curing resin; compressing the ultraviolet curing resin flatly to squeeze the space and eliminate the air remained between the thin film and the ultraviolet curing resin as well as the ultraviolet curing resin and the transparent mold cavity; and performing a light projection to pass light through the transparent mold cavity to cure the ultraviolet curing resin, so as to complete manufacturing the keypad panel.

### BACKGROUND OF THE INVENTION

1. Field of the Invention

The present invention generally relates to a keypad panel, and more particularly to a manufacturing method of a keypad panel.

2. Description of Prior Art

Keypad panel applied to a product such as a mobile phone tends to be lightweight, super thin, backlight and modulated, and also emphasizes on a diversified appearance and an integral design. Technically, the keypad panel tends to reduce the number of component modules and the gap between keys, and features a backlight, a metal appearance, a soft or silk texture, and a high integrity, and thus the design and technology of a keypad panel become important subjects for the research and development of mobile phones.

In the manufacture of a traditional keypad panel of a mobile phone, it is necessary to prepare a mold 100 (as shown in FIG. 1) composed of an opaque male mold 200 and a female mold 300. The male mold 200 includes a plurality of openings 201, and a lateral side of the opening 201 includes a screw hole 202, and the opening 201 is provided for fixing a transparent mold plate 203 with a light transmittance, and a surface of the transparent mold plate 203 includes a first model 204 having a protruded keypad panel, and a lateral side of the first model 204 includes a through hole 205 for passing through a screw 206 to secure the transparent mold plate 203 to the opening 201. The female mold 300 includes a plurality of second models 301 corresponding to the first models 204. In the manufacture of a keypad panel, a plastic material is injected between the male mold 200 and the female mold 300, and then the plastic will fill up the space between the first and second models 204, 301 of the male mold 200 and the female mold 300. During a light projection, light will pass through the transparent mold plate 203 to cure the plastic, so as to complete manufacturing the keypad panel.

Since the manufacture of the keypad panel requires securing the transparent mold plates 203 to the male mold 200 one by one, therefore the manufacturing process of the keypad panel takes more manufacturing time and procedures for assembling the male mold. If one of the second models 301 of the female mold 300 is damaged, it is necessary to replace the whole female mold 300, and thus causing a waste of female mold 300. Furthermore, when the light curing projection is performed, light can be projected from a lateral side of the male mold 200 only, but cannot be projected from a lateral side of the female mold 300, and thus the light projecting direction is limited, and the keypad panels of a particular model can be made one at a time only.

In addition, when the transparent mold plate 203 uses a through hole 205 at its diagonal to pass a screw 206 through the opening 201 of the male mold 200, a seam may be created when the opening 201 and the transparent mold plate 203 are engaged with each other at their lateral sides, since the opening 201 and the transparent mold plate 203 are not secured by any screw 206, and a plastic leak occurs easily, when the plastic is injected into the male and female molds 200, 300.

### SUMMARY OF THE INVENTION

It is a primary objective of the present invention to provide a simple and easy mold, so as to make the installation of the mold easier without a plastic leak, and allow manufacturers to perform a light curing from the top or the bottom of the mold. Manufacturer simply requires changing a transparent mold core of the mold for the manufacture of different models of keypad panels.

To achieve the foregoing objectives, the present invention provides a manufacturing method of a keypad panel, and the method comprises the steps of preparing a mold composed of a mold base, a transparent mold core and a fixed plate; coating an ultraviolet curing resin onto surfaces of the mold base and the transparent mold core of the mold; attaching a transparent or non-transparent plastic thin film on top of the ultraviolet curing resin after the ultraviolet curing resin is coated; pressing the ultraviolet curing resin flatly to squeeze the air between the thin film and the ultraviolet curing resin, and between the ultraviolet curing resin and the transparent mold core, and between the mold base and the transparent mold core to the outside to prevent any remaining air; and finally performing a light projection to allow light to pass through the transparent mold core to solidify the ultraviolet curing resin, so as to complete manufacturing the keypad panel after the ultraviolet curing resin is cured.

### BRIEF DESCRIPTION OF DRAWINGS

FIG. 1 is a perspective view of a mold for manufacturing a prior art keypad panel;

FIG. 2 is a flow chart of manufacturing a keypad panel of the present invention;

FIG. 3 is an exploded view of a mold of the present invention;

FIG. 4 is a section view of an assembly as depicted in FIG. 3;

FIG. 5 is a schematic view of an application of a mold in accordance with the present invention;

FIG. 6 is a schematic view of another application of a mold in accordance with the present invention;

FIG. 7 is a schematic enlarged view of a portion of FIG. 6;

FIG. 8 is a schematic view of a light illumination in accordance with the present invention;

FIG. 9 is an exploded view of another mold of the present invention;

FIG. 10 is a section view of an assembly as depicted in FIG. 9;

FIG. 11 is a schematic view of a preferred embodiment of the present invention; and

FIG. 12 is a schematic view of another preferred embodiment of the present invention.

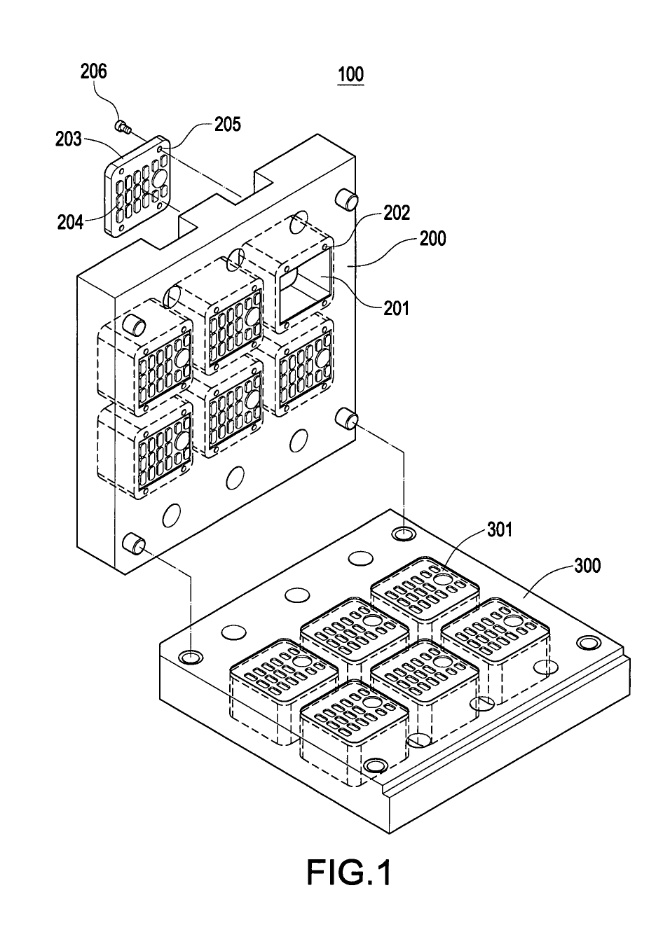

### DETAILED DESCRIPTION OF THE INVENTION

The technical characteristics, features and advantages of the present invention will become apparent in the following detailed description of the preferred embodiments with reference to the accompanying drawings.

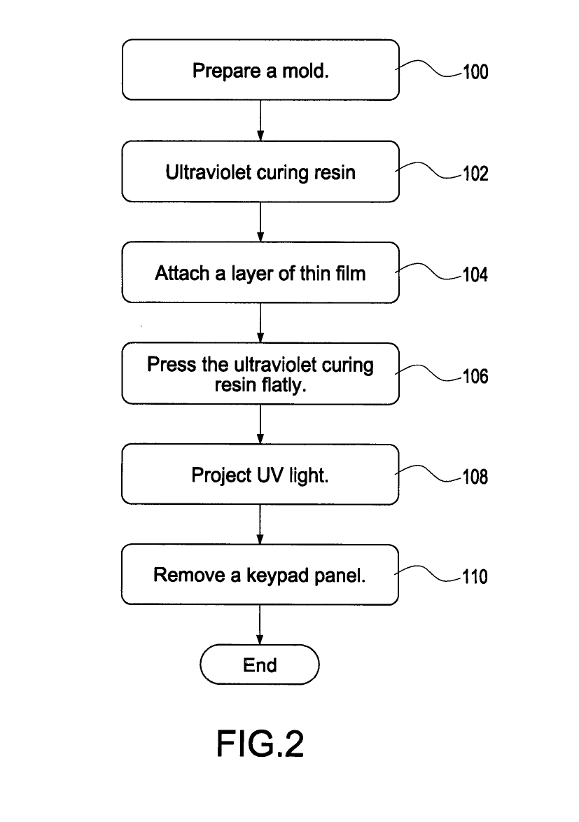

Referring to FIG. 2 for a flow chart of manufacturing a keypad panel of the present invention, the manufacturing method of a keypad panel comprises the following steps:

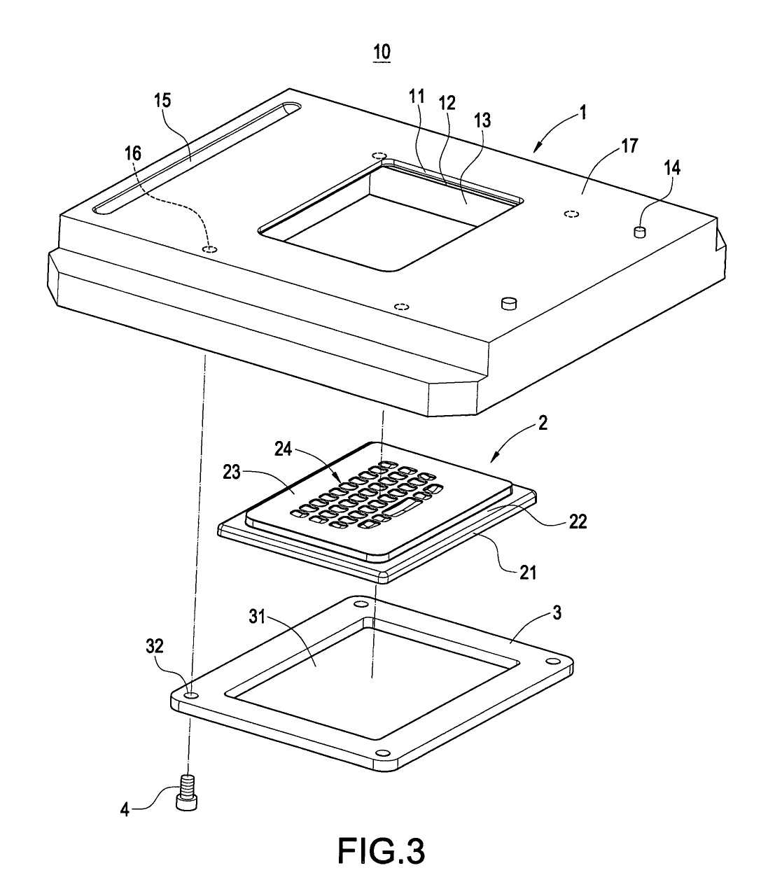

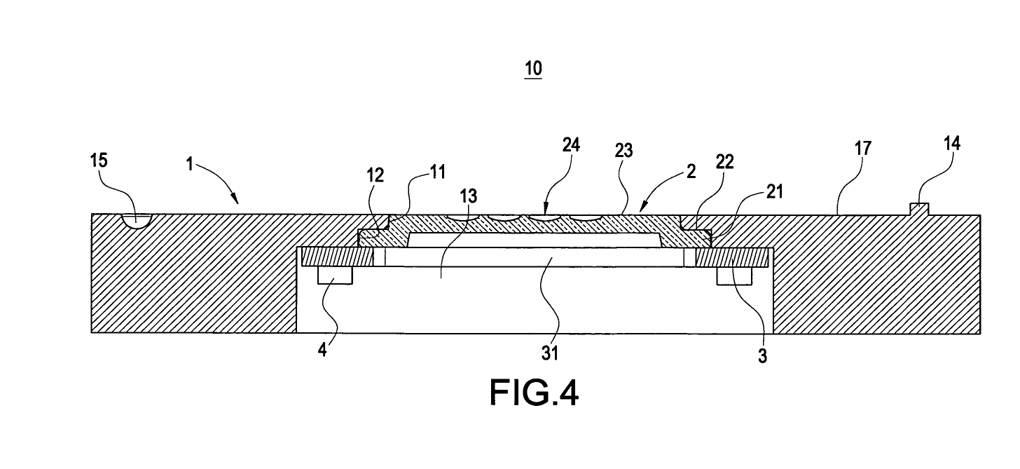

In Step 100, a mold 10 is prepared (as shown in FIGS. 3 and 4), wherein the mold 10 comprises: a mold base 1, a transparent mold core 2 and a fixed plate 3. The mold base 1 includes an opening 11 thereon, and an internal periphery of the opening 11 includes a stairway-like joint portion 12 for installing the transparent mold core 2, and the opening 11 is provided for exposing a surface 23 of the transparent mold core 2. A containing space 13 is extended from the joint portion 12 of the mold base and interconnected with the opening 11, such that when the transparent mold core 2 is installed into the opening 11, the fixed plate 3 can be installed into the containing space 13 to press the transparent mold core 2, and the periphery of the transparent mold core 2 can be attached with the internal periphery of the opening 11. Further, a surface 17 of the mold base 1 includes a positioning portion 14 and a groove 15, wherein the positioning portion 14 is provided for positioning a thin film (not shown in the figure), and the groove 15 is provided for preventing a plastic overflow. The interior of the mold base 1 includes a plurality of screw holes 16 in the containing space 13 for securing a plurality of screws 4. The periphery of the main body 21 of the transparent mold core 2 includes a stairway-like joint edge 22, such that when the transparent mold core 2 and the mold base 1 are installed, the joint edge 22 of the transparent mold core 2 is connected onto the joint portion 12. The surface 23 of the transparent mold core 2 includes a model 24 having the shape of a keypad panel and provided for forming the shape of the keypad panel. The fixed plate 3 has an opening 31 provided for passing and projecting a light onto the transparent mold core 2, and the diagonal of the opening 31 has a plurality of through holes 32 provided for passing and securing a screw 4 into a screw hole 16 of the mold base 1, so as to install the fixed plate 3 into the containing space 13 of the mold base 1.

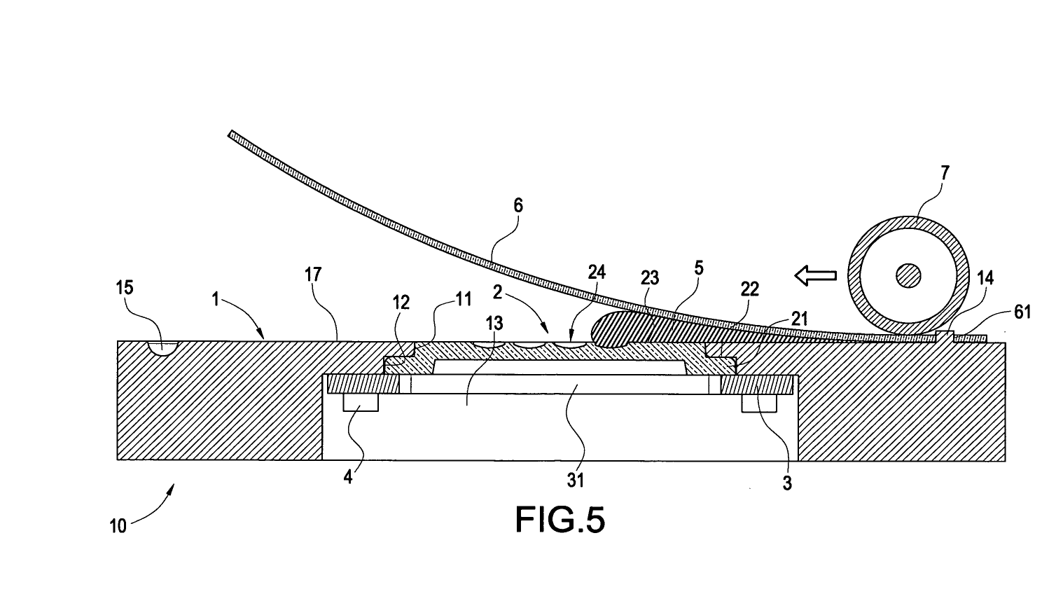

In Step 102, an ultraviolet curing resin 5 is dispensed onto the surface 17 of the mold base 1 or the surface 23 of the transparent mold core 2 of the mold as shown in FIG. 5, after the mold is assembled.

In Step 104, a plastic thin film 6 is attached, wherein the plastic thin film 6 is made of a transparent or non-transparent plastic material, and the thin film 6 includes a positioning hole 61 sheathed onto the positioning portion 14 of the mold base 1 and pressed into the ultraviolet curing resin 5 as shown in FIG. 5. In this preferred embodiment, the plastic thin film 6 is printed with a printed circuit board or a touch panel.

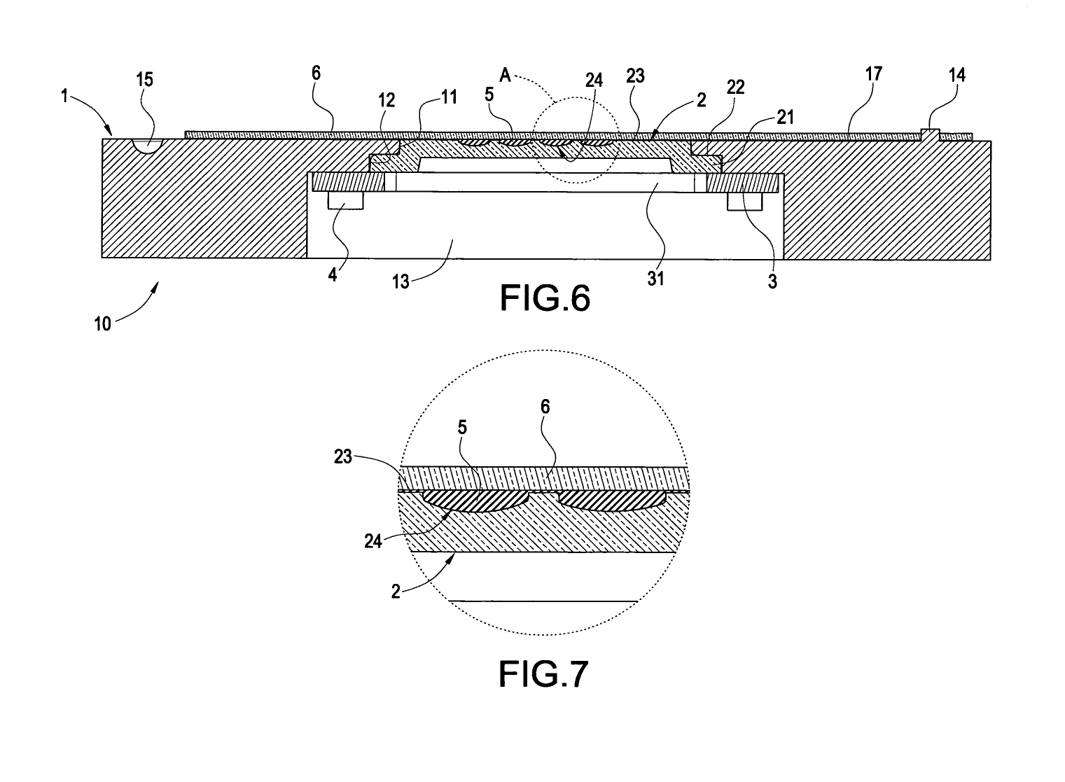

In Step 106, the ultraviolet curing resin is pressed flatly, and a scraper or a roller 7 is used for scraping the plastic thin film 6 to squeeze the air between the plastic thin film 6 and the ultraviolet curing resin 5, and between the ultraviolet curing resin 5 and the model 24 of the transparent mold core 2 to the outside, so as to prevent air from remaining between the plastic thin film 6 and the ultraviolet curing resin 5 and between the ultraviolet curing resin 5 and the model 24 to form bubbles as shown in FIGS. 6 and 7. In the scraping or roll pressing process, the ultraviolet curing resin 5 is overflowed and the ultraviolet curing resin 5 may flow into the groove 15.

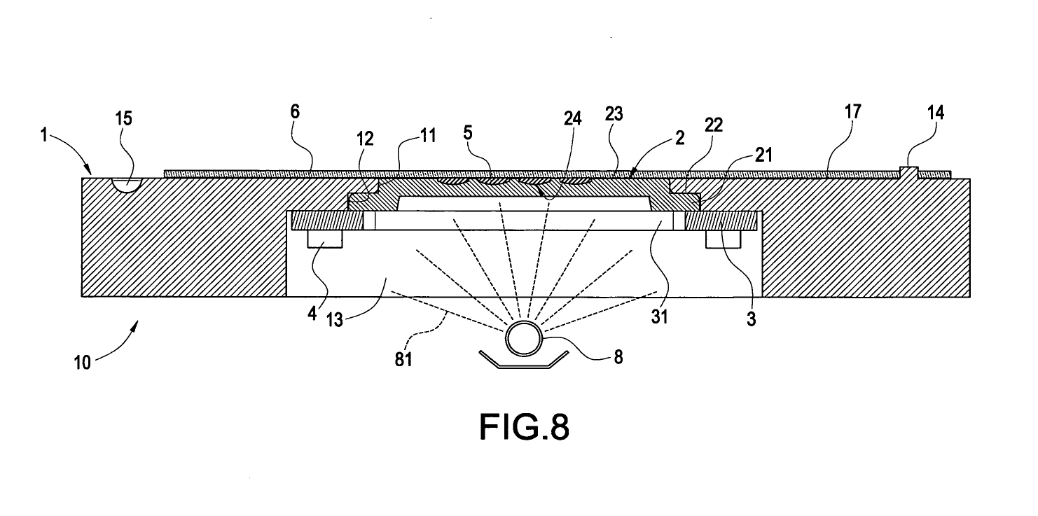

In Step 108, an ultraviolet light is projected as shown in FIG. 8, and an ultraviolet lamp 8 is installed at the bottom of the mold base 1 and corresponding to the transparent mold core 2, such that when the ultraviolet lamp 8 is lit, the produced ultraviolet light 81 passes through the opening 31 of the fixed plate 3 and then through the main body of the transparent mold core 2, so as to solidify the ultraviolet curing resin 5. If the plastic thin film 6 is opaque, the ultraviolet lamp 8 can be installed at the bottom of the mold base 1. If the plastic thin film 6 is transparent, the ultraviolet lamp 8 can be installed at the top the mold base 1 to project an ultraviolet light 81 onto the ultraviolet curing resin 5.

In Step 110, the keypad panel is removed to complete manufacturing the keypad panel after the projection of ultraviolet light 81 is finished.

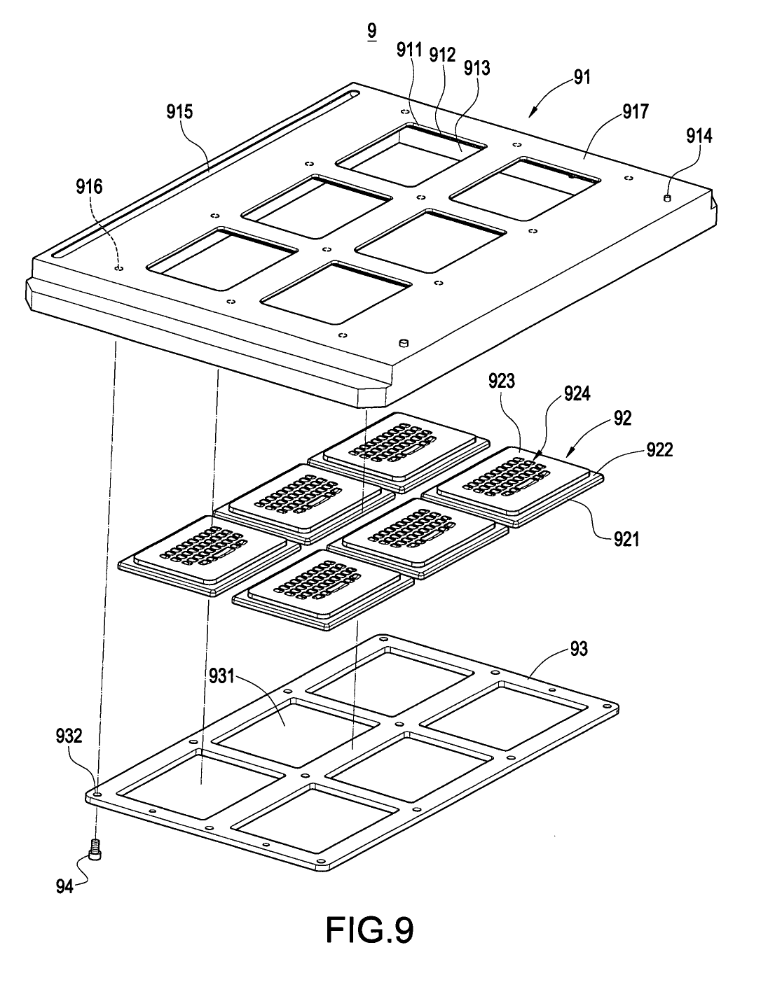

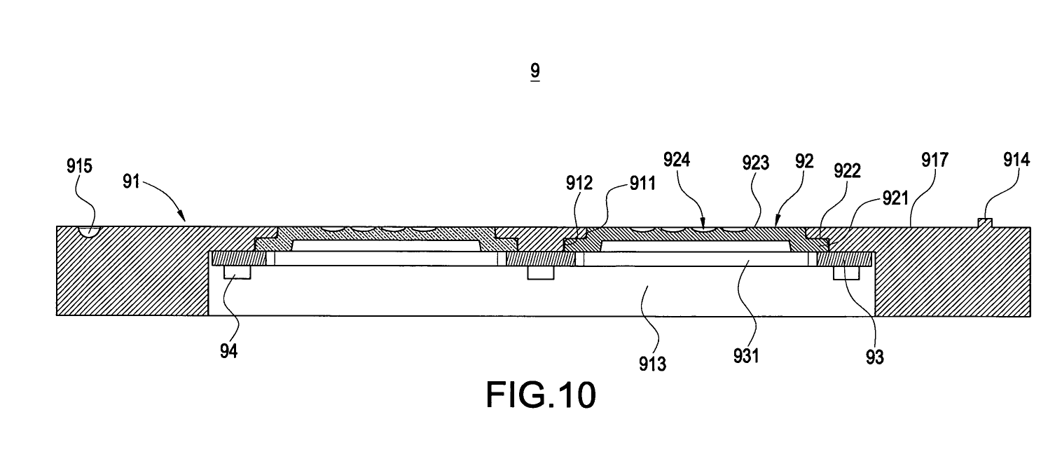

Referring to FIGS. 9 and 10 for another preferred embodiment of the present invention and a section view of an assembly as depicted in FIG. 9 respectively, the mold 9 of the invention comprises: a mold base 91, a transparent mold core 92 and a fixed plate 93.

The mold base 91 includes a plurality of openings 911, and the internal periphery of each opening 911 has a stairway-like joint portion 912 for connecting the transparent mold core 92, while the opening 911 is provided for exposing the a surface 923 of the transparent mold core 92. A containing space 913 with a plurality of joint portions 912 are jointly extended from the mold base 91 and the containing space 913 is interconnected with the opening 911, such that when the transparent mold core 92 is installed into the opening 911, the fixed plate 93 can be installed into the containing space 913 to press the transparent mold core 92, and the periphery of the transparent mold core 92 can be attached with the internal periphery of the opening 911. Further, the surface 917 of the mold base 1 includes a cylindrical positioning portion 914 and a rectangular groove 915, and the positioning portion 914 is provided for positioning a thin film (not shown in the figure), and the groove 915 is provided for the use of a plastic overflow. The interior of the mold base 91 includes a plurality of screw holes 916 disposed in the containing space 913 for securing screws 94.

The periphery of a main body 921 of the transparent mold core 92 includes a substantially stairway-like joint edge 922, such that when the transparent mold core 92 and the mold base 91 are installed, the joint edge 922 of the transparent mold core 92 can be coupled onto the joint portion 912. Further, the surface 923 of the transparent mold core 92 includes a model 924 in the shape of a keypad panel to form the shape of the keypad panel.

The fixed plate 93 includes an opening 931 for passing and projecting a light onto the transparent mold core 92, and the diagonal of the opening 931 has a plurality of through holes 932 for passing and securing a screw 94 into a screw hole 916 of the mold base 91 to install the fixed plate 93 into the containing space 913 of the mold base 91.

After a plurality of transparent mold cores 92 are installed sequentially into the opening 911 of the mold base 91, the fixed plate 93 is installed into the containing space 913 of the mold base 91, and a piece of fixed plate 93 is used to press the plurality of transparent mold cores 92, and this design facilitates installing, removing or changing a transparent mold core 92. Further, the transparent mold core 2, 92 can be changed to manufacture various kinds of keypad panels.

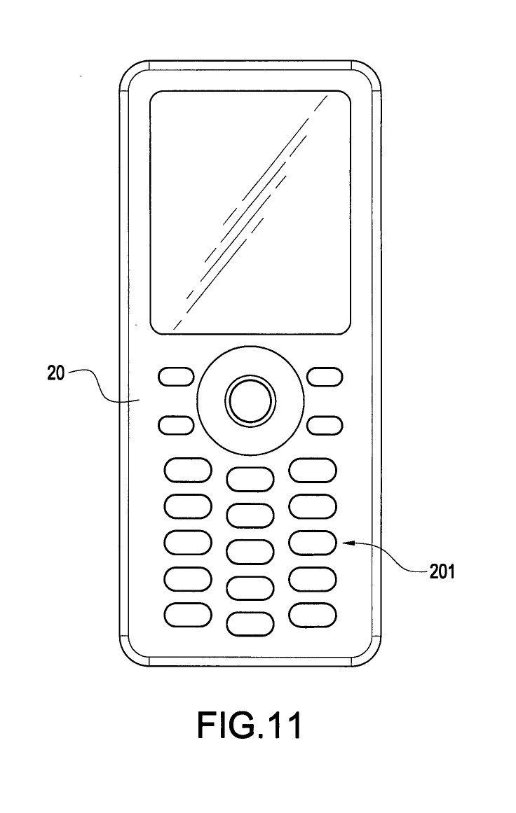

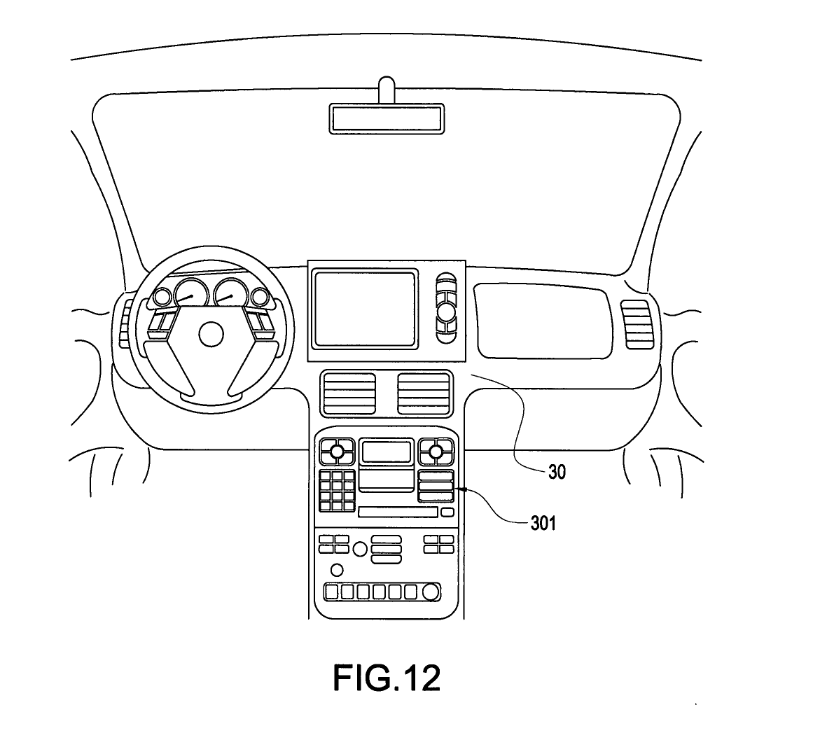

Referring to FIG. 11 for a schematic view of a preferred embodiment of the present invention, the mold and its manufacturing method in accordance with the present invention are used for the production of a keypad panel 301 applied in a mobile phone 20. In the manufacture of the keypad panel 201 of the mobile phone 20, manufacturers simply need to change the transparent mold core of the mold into a pattern of the keypad panel 30 of the mobile phone 20 to produce the keypad panel 201 of the mobile phone 20.

Referring to FIG. 12 for a schematic view of another preferred embodiment of the present invention, the mold and its manufacturing method in accordance with the present invention are used for the production of a keypad panel 301 applied in an automobile meter panel 30. In the manufacture of the keypad panel 301 of the automobile meter panel 30, manufacturers simply need to change the transparent mold core of the mold to produce dedicated keypad panels 201 of the automobile meter panel 30.

While the invention is described in by way of example and in terms of preferred embodiments, it is to be understood that the invention is not limited thereto. On the contrary, the aim is to cover all modifications, alternatives and equivalents falling within the spirit and scope of the invention as defined by the appended claims.

What is claimed is:

1. A manufacturing method of a keypad panel, comprising the steps of:
(a) preparing a mold composed of a mold base, at least one transparent mold core and a fixed plate;
(b) coating an ultraviolet curing resin onto surfaces of the mold base and the transparent mold core;
(c) attaching a thin film on top of the ultraviolet curing resin;
(d) pressing the ultraviolet curing resin onto surfaces of the thin film, the mold base and the transparent mold core;
(e) performing a light projection; and
(f) removing the keypad panel to complete manufacturing the keypad panel after the ultraviolet curing resin is cured.

2. The manufacturing method of a keypad panel as recited in claim 1, wherein the mold base of Step (a) has at least one opening, and an internal periphery of the opening has a stairway-like joint portion.

3. The manufacturing method of a keypad panel as recited in claim 2, wherein the joint portion has a containing space extended from the joint portion and interconnected with the opening.

4. The manufacturing method of a keypad panel as recited in claim 3, wherein the containing space includes a plurality of screw holes.

5. The manufacturing method of a keypad panel as recited in claim 2, wherein the mold base includes a positioning portion and a groove, both disposed on a surface of the mold base.

6. The manufacturing method of a keypad panel as recited in claim 1, wherein the transparent mold core of Step (a) has a main body, and a periphery of the main body has a stairway-like joint edge.

7. The manufacturing method of a keypad panel as recited in claim 6, wherein the joint edge of the transparent mold core is installed onto the joint portion, when the transparent mold core and the mold base are installed.

8. The manufacturing method of a keypad panel as recited in claim 6, wherein the transparent mold core has a model having a shape of a keypad panel and disposed on a surface of the transparent mold core.

9. The manufacturing method of a keypad panel as recited in claim 1, wherein the fixed plate of Step (a) has at least one an opening, and a periphery of the opening has a plurality of through holes for securing at the mold base.

10. The manufacturing method of a keypad panel as recited in claim 1, wherein the thin film of Step (c) is made of a transparent plastic material.

11. The manufacturing method of a keypad panel as recited in claim 1, wherein the thin film of Step (c) is made of an opaque plastic material.

12. The manufacturing method of a keypad panel as recited in claim 1, wherein the thin film of Step (c) has a positioning hole sheathed onto a positioning portion of the mold base.

13. The manufacturing method of a keypad panel as recited in claim 1, wherein the thin film of Step (c) is printed with one selected from the collection of a printed circuit board or a touch panel.

14. The manufacturing method of a keypad panel as recited in claim 1, wherein the ultraviolet curing resin of Step (d) is pressed flatly by a tool selected from the collection of a level tool or a roll pressing tool.

15. The manufacturing method of a keypad panel as recited in claim 10, wherein the level tool is a scraper.

16. The manufacturing method of a keypad panel as recited in claim 10, wherein the roll pressing tool is a roller.

17. The manufacturing method of a keypad panel as recited in claim 1, wherein the light projection of Step (e) is an ultraviolet light projection.

18. The manufacturing method of a keypad panel as recited in claim 17, wherein the ultraviolet light projection is produced by an ultraviolet lamp.

19. The manufacturing method of a keypad panel as recited in claim 18, wherein the ultraviolet lamp is installed at a position selected from the collection of a top or a bottom of the mold base.
